(19) United States
(12) Patent Application Publication
(10) Pub. No.: US 2012/0055069 A1
(43) Pub. Date: Mar. 8, 2012

(54) Rod hugger reel clamp

(76) Inventor: Alexander Justin Mobile, Long Beach, CA (US)

(21) Appl. No.: 12/931,273

(22) Filed: Apr. 14, 2010

(51) Int. Cl. A01K 87/06

(52) U.S. Cl. 43/22

(57) ABSTRACT

This improvement to the standard reel clamp for a fishing reel is manufactured with nuts that are self-contained with the aid of a collar on each end of the nut. The collars keep the nuts from being lost during the process of storage and ease the installation of reels on the fishing rod. The nuts can be loosened to remove and attach fishing reels, but because the flanges at the ends of the nuts are larger than the nuts themselves, they will not fall out of or get lost from the reel clamp.

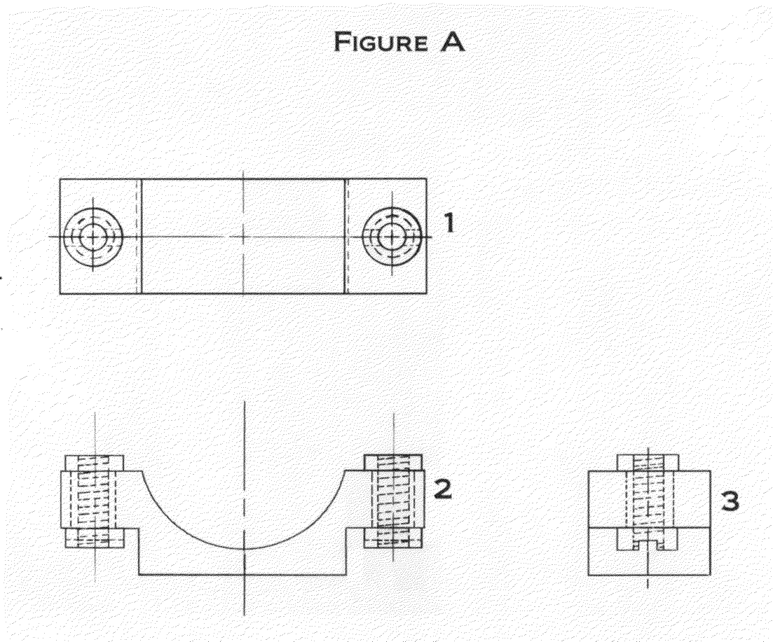

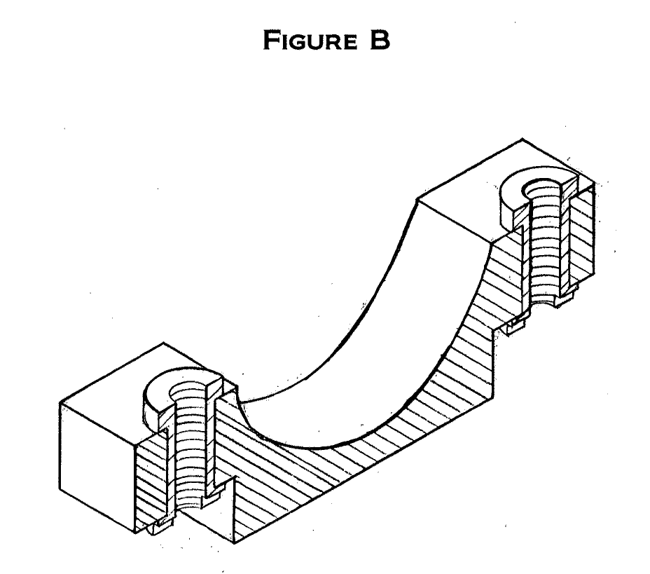

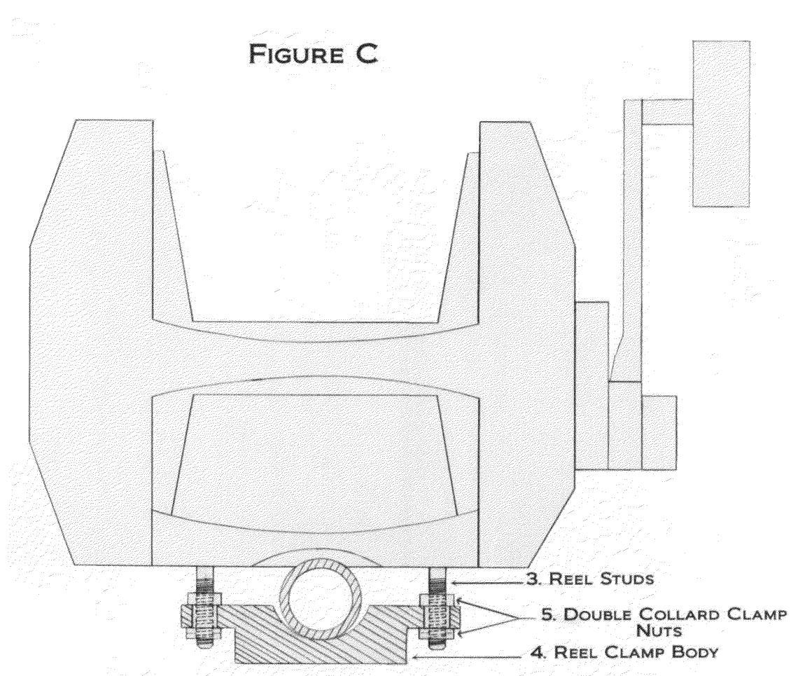

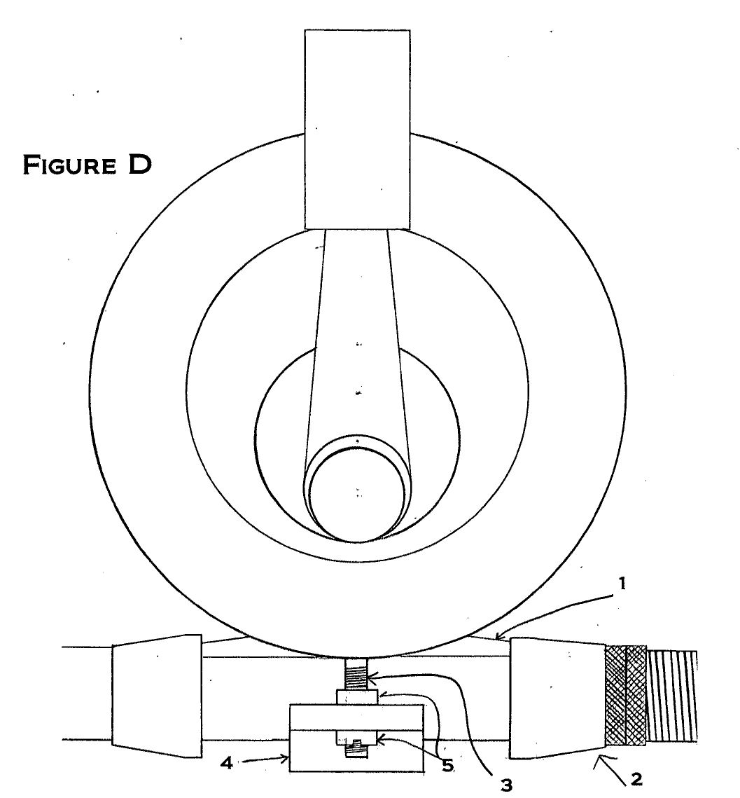

The rod hugger clamp is a unique innovation of a simple product. Rather than having two nuts and a separate reel clamp, the nuts are self-contained in the reel clamp by a collar/flange on each end of the nut. This enables all parts of the clamp to be completely self-contained. Now, what was once three parts is now one. This eliminate the possibility of losing either one or both of the screws that are used to secure the fishing reel to the fishing rod.

### CROSS REFERENCE TO RELATED APPLICATIONS

UPC Class—43 (Fishing, trapping, etc.) D22 (Hunting and fishing equipment)

Subclass—142 (Rods, includes reel support)

### STATEMENT REGARDING FEDERALLY SPONSORED RESEARCH

No funds have been contributed by the Federal Government to develop this design idea.

### DESCRIPTION OF THE DRAWING FIGURES

FIGURE A: Is the standard engineering drawing of the front, top and right side view of the clamp

FIGURE B: Is a cross-section isometric drawing of the clamp.

FIGURE C: Illustrates how the clamp, (part number 4) attaches to the fishing reel studs (part number 3) by tightening the double collar clamp nuts (part number 5) to the reel studs. This pinching the fishing rod between the clamp and the reel.

FIGURE D: Side view of the reel clamp attaching to the fishing rod. Illustration shows part number 4 attached to the fishing reel studs (part number 3) by tightening the double clamp nuts (part number 5) to the reel studs, thus, pinching the fishing rod between the clamp and the reel.

1. A reel clamp specifically designed by Alexander Mobile to attach a fishing reel to a fishing rod with self-contained nuts. The reel clamp is a manufactured rectangular piece of metal with a slight arch in the middle to contour to the fishing rod. Each end of the clamp has a round nut that passes through a hole. Each end of the nut has a collar/flange that keeps the nuts in the rectangular clamp. Each nut has a slot cut in the end of it, so that a screw driver can be used to tighten or loosen them. The nuts are screwed to the fishing reel via the two reel studs on the bottom of the fishing reel that are provided with the clamp or by the reel manufacturer. The nuts are also made of metal such as brass, aluminum or stainless steel. Incorporated into this claim by description are drawings Figure A, Figure B, Figure C, and Figure D, submitted with the original application. The collar/flange mechanism prevents the nuts from being lost when the clamp is removed.
